(19) United States
(12) Patent Application Publication
(10) Pub. No.: US 2010/0080317 A1
(43) Pub. Date: Apr. 1, 2010

(54) SYMBOL MIXING ACROSS MULTIPLE PARALLEL CHANNELS

(75) Inventors: Ravi Narasimhan, Los Altos, CA (US); Andrea Goldsmith, Menlo Park, CA (US)

Correspondence Address: PERKINS COIE LLP, P.O. BOX 1208, SEATTLE, WA, 98111-1208, US

(73) Assignee: Quantenna Communications, Inc., Fremont, CA (US)

(21) Appl. No.: 12/572,250

(22) Filed: Oct. 1, 2009

Related U.S. Application Data
(60) Provisional application No. 61/101,961, filed on Oct. 1, 2008.

(51) Int. Cl. H04L 1/02

(52) U.S. Cl. 375/267

(57) ABSTRACT

Symbol mixing across multiple input multiple output (MIMO) parallel channels is disclosed. Each data symbol is transmitted over an effective channel with a weighted sum of the singular values associated with all spatial channels. By averaging the singular values, there is less of a penalty associated with the choice of modulation and coding on the data symbols, since all transmitted symbols experience roughly the same signal to noise ratio (SNR) in transmission.

### CROSS-REFERENCE TO RELATED APPLICATIONS

This application claims priority to U.S. Provisional Patent Application No. 61/101,961, filed on Oct. 1, 2008, and which is incorporated by reference.

### BACKGROUND

Parallel channels, such as those found in multiple input multiple output (MIMO) wireless communications, can be exploited to improve some characteristics of data transmission, such as bit error rate and/or data rate, by sending different data streams over different channels. In MIMO systems, spatial multiplexing decomposes a MIMO channel into separate spatial channels. The signal-to-noise ratio (SNR) on each spatial channel depends on the singular value decomposition of the MIMO channel matrix. In particular, the SNR of a spatial channel is proportional to its associated singular value.

A stream sent over a spatial channel with a large SNR can typically support higher data rates than a stream sent over a spatial channel with a small SNR with all other performance characteristics (such as bit error rate) staying the same. To take advantage of different SNRs per spatial channel, MIMO systems may adapt the modulation and coding of each spatial channel to its SNR. For example, the 802.11n standard allows different modulation and coding values to be assigned to different spatial data streams.

The complexity associated with having different modulation and coding for different spatial streams causes some systems to keep the modulation and coding the same for all spatial streams. In other words, in such MIMO systems the same modulation and coding would be used on all spatial channels. However, when modulation and coding is the same for all spatial channels/streams, performance can suffer. Specifically, in such systems the modulation and coding choice can be conservative (i.e. small signal constellations and/or high code rates) to keep the bit error rate low on all spatial channels, but then data throughput may suffer since larger constellations or small code rates on spatial channels with large SNRs could increase throughput. Alternatively, the modulation and coding choice on all spatial channels can be aggressive (i.e. large signal constellations or low code rates) to make the data rate high, but then the bit error rate on spatial channels will be high, which may reduce overall throughput and/or increase delay.

These types of issues are applicable to both MIMO wireless communications systems and other parallel channel configurations, such as systems that implement orthogonal frequency division multiplexing (OFDM) and systems implementing parallel physical cables. For OFDM systems, a modulator modulates over multiple frequencies (and demodulates upon receipt), while in a parallel physical cable system, a multiplexor multiplexes over multiple physical cables (and demultiplexes upon receipt).

### SUMMARY

The following is described and illustrated in conjunction with systems, tools, and methods that are meant to be exemplary and illustrative, not limiting in scope. In various embodiments, one or more of the above-described problems have been reduced or eliminated, while other embodiments are directed to other improvements.

Symbol mixing across multiple input multiple output (MIMO) parallel channels includes averaging out the singular values associated with multiple spatial streams by sending weighted sums of the coded/modulated data (data symbols) over each spatial channel. That way each data symbol is transmitted over an effective channel with a weighted sum of the singular values associated with all spatial channels. By averaging the singular values over all parallel channels, there is much less of a penalty associated with a single choice of modulation and coding on the data symbols, since all transmitted symbols experience roughly the same signal to noise ratio (SNR) in transmission.

These techniques are applicable to known or convenient parallel channel systems that do not incorporate MIMO, such as orthogonal frequency division multiplexing (OFDM) systems and systems implementing multiple parallel cables. For example, although the channels of a system implementing parallel cables are largely static, priority weighting of bits can be dynamic.

### BRIEF DESCRIPTION OF THE DRAWINGS

Examples of the claimed subject matter are illustrated in the figures.

FIG. 1 depicts an example of a symbol mixing system.

FIG. 2 depicts an example of a MIMO wireless communication system.

FIGS. 3 and 4 depict illustrative examples of SINR across frequencies for spatial streams not using symbol mixing.

FIGS. 5-7 depict illustrative examples of SINR across frequencies for spatial streams using symbol mixing.

FIG. 8 depicts a flowchart of an example of a method for alternately operating a wireless station with and without the use of symbol mixing.

FIG. 9 depicts a flowchart of an example of a method for symbol mixing.

FIG. 10 depicts an example of a system that includes wireless MIMO stations.

### DETAILED DESCRIPTION

In the following description, several specific details are presented to provide a thorough understanding of examples of the claimed subject matter. One skilled in the relevant art will recognize, however, that one or more of the specific details can be eliminated or combined with other components, etc. In other instances, well-known implementations or operations are not shown or described in detail to avoid obscuring aspects of the claimed subject matter.

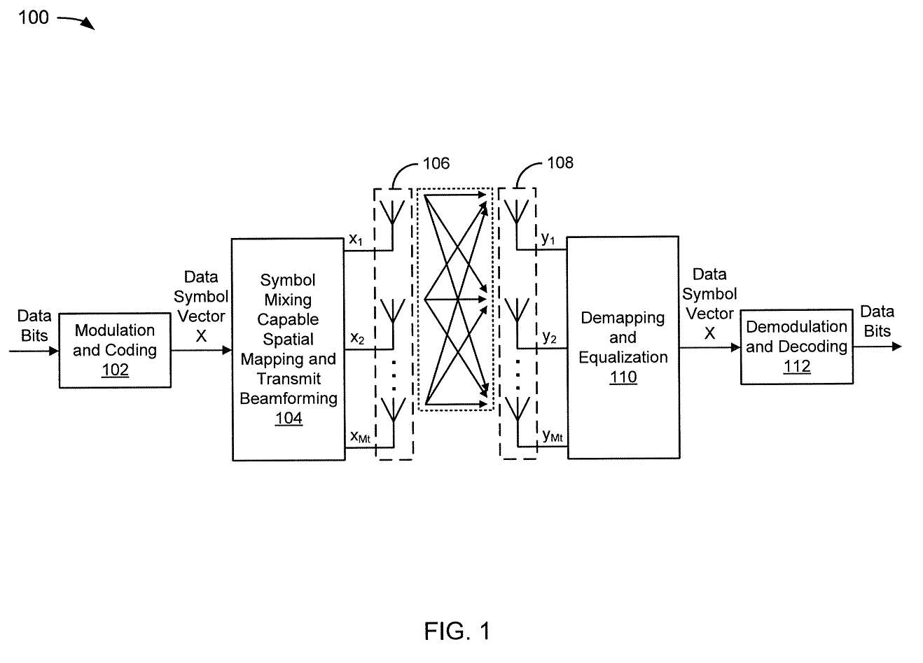

FIG. 1 depicts an example of a symbol mixing system 100. In the example of FIG. 1, the system 100 includes a one-size-fits-all channel allocation block 102, a symbol mixing block 104, a multiple parallel channel (MPC) communication subsystem 106, a channel estimation block 108, a symbol unmixing block 110, and a one-size-fits-all channel deallocation block 112.

In the example of FIG. 1, the one-size-fits-all channel allocation block 102, as illustrated in the example figure, has data bits from an application as input and data symbol vector X as output. The data symbol vector X can be defined as X=[x₁, . . . , x_{Ns}], for dimension Nₛ. For illustrative purposes, in an orthogonal frequency division multiplexing (OFDM) system with N tones, the vector Xₖ can be generated for each tone. Thus, Xₖ: Nₛ×1 vector constellations for tone k. It may be noted that for non-OFDM systems, N is typically 1.

In this example, the meaning of “one-size-fits-all” is that the data bits use, for example, the same multiplexing or modulation and coding configuration, to allocate data bits to the multiple parallel channels. The configuration can vary depending upon the implementation. For example, the configuration could be a design choice made at the time of manufacture. In systems with dynamically changing channel characteristics, it may be desirable to change the configuration based upon channel estimation. In such a case, the configuration is uniform for a first group of data bits received in a time period 0, but can change over time for a second group of data bits received in a time period 1. So the channel allocation remains “one-size-fits-all” for a particular group of data bits, but can be referred to as a dynamic configuration in that the configuration can change over time in response to dynamically changing channel characteristics.

In the example of FIG. 1, the symbol mixing block 104 has bit priorities as input from the application, the data symbol vector X as input from the one-size-fits-all channel allocation block 102, and estimated channel parameters from the channel estimation block 108 (described later); and transmit data symbol vector V as output. It should be noted that the application can include one or more applications and the system 100 can further include a bit prioritization block (not shown), logically between the application and the symbol mixer, that determines bit priorities for the application even if the application does not provide explicit bit priorities. The symbol mixing block 104 maps the vector of data symbols X into a vector of transmit symbols V=[vₗ, . . . v_{N}] to be transmitted over multiple parallel transmit channels where each vᵢ is a linear combination of [x₁, . . . , x_{Ns}]. The mapping can be accomplished by left multiplying a mixing matrix (e.g., a discrete Fourier transform (DFT) or Hadamard transform matrix) across the Nₛ streams. The mixing matrix could be unitary for considerations relative to noise statistics. Additional constraints may be placed on the mixing matrix for better performance.

In this paper, symbol mixing refers to the transformation of X to V, where each vᵢ of V=[v₁, . . . v_{N}] is a function of a subset of X=xₖ=αDₖV_{H,k,1}F_{Ns}Xₖ where constant α=(P/N)^{1/2} is chosen to satisfy per-channel power constraints, Dₖ is chosen such that the average power per-antenna and per-tone is constant, V_{H,k,1} is Mₜ×Nₛ matrix consisting of the 1^{st} Nₓ columns of the right singular matrix V_{H,k}, and F_{Ns} is a mixing matrix. For per-channel, per-tone singular value decomposition (SVD) scaling, Dₖ=diag((V_{H,k,1}V*_{H,k,1})_{1,1}^{-1/2}, . . . , (V_{H,k,1}V*_{H,k,1})_{Mt,Mt}^{-1/2}). For per-channel, SVD scaling across all tones Dₖ=diag(P^{1/2}Σ^{N-1}ₖ₌₀(V_{H,k,1}V*_{H,k,1})_{1,1}^{-1/2}, . . . , P^{1/2}(Σ^{N-1}ₖ₌₀(V_{H,k,1}V*_{H,k,1})_{Mt,Mt}^{-1/2}). It may be noted that for OFDM, Vₖ=[V₁ₖ, . . . , V_{Nk}], but for illustrative simplicity, V is described in this paper with the understanding that one of skill in the relevant art would understand that OFDM uses slightly different formulae.

Although any applicable convenient technique can be used, SVD is a common beamforming technique that is typically used in MIMO wireless systems. Alternatively, under a per-channel power constraint symbols can be transmitted at a limit of allowed transmit power. For example, the optimal performance may be based on trying to equalize the effective SNR on each data symbol, maximizing throughput, meeting delay constraints, meeting robustness constraints, or some combination of these. The linear combination of [x₁, . . . , x_{R}] may take into account data priorities so that high priority data has larger weights than low priority data.

Using spatial symbol mixing, each element in X can be sent over multiple spatial channels, thereby experiencing the average signal to noise ratio (SNR) associated with each of the spatial channels. Advantageously, when used in combination with a one-size-fits-all channel allocation block, it is not necessary to be conservative and use channel parameters for the worst channel for each of the data symbols xᵢ, which is associated with reduced performance because of the inability to take advantage of the relatively good channels, or to be aggressive and use channel parameters for the best channel—or at least a channel that is not the worst—and risk an increased incidence of errors.

The symbol mixing block 104 can use bit priorities and channel characteristics to identify the most suitable channels over which to mix bits. In particular, high priority data bits can be mixed across channels with high SNRs such that the averaged SNR after symbol mixing is high, while low priority data bits can be mixed across channels with low SNRs such that the averaged SNR after symbol mixing is low, thereby reducing the probability of error and/or delay of the high priority data bits. Even where dynamic channel estimation is not particularly valuable, such as with multiple parallel channels implemented with multiple physical cables, this method of mixing high priority data bits over the high-SNR channels and low-priority data bits over the low-SNR channels can be used to provide different performance to the different classes of bits. It should be understood that high priority is relative to low priority, rather than some absolute standard even in systems that have specific designations (e.g., if “high priority” is defined for a particular protocol that has an even higher priority designation, such as “voice priority,” low priority in this paper could refer to data that is defined as “high priority” when other data has a “voice priority” designation). Bit priorities can also enable sending data in accordance with acceptable probability of error. Depending upon the implementation and/or configuration, this may or may not result in lower priority bits being dropped if in order to meet the performance requirements of the high priority bits, these bits needed to be mixed across all parallel channels, leaving no additional channels over which to send the low priority bits. This could also result in no bits being sent if acceptable probability of error requirements cannot be met after mixing over all parallel channels (perhaps triggering an attempt to reroute the data path, if circumstances permit).

When implemented with a channel estimation block 108, the symbol mixing block 104 maps the vector of data symbols, X, into a vector of transmit symbols, V, in accordance with estimated channel parameters from the channel estimation block 108. This can facilitate improved performance relative to transmit power constraints and time-variable channel characteristics. Thus, data symbols can be mapped differently when channel characteristics change. When used in conjunction with bit prioritization, channel estimation enables multi-dimensional mapping functionality that takes into account both bit priorities and channel characteristics (as well as, in some embodiments, default mapping preferences).

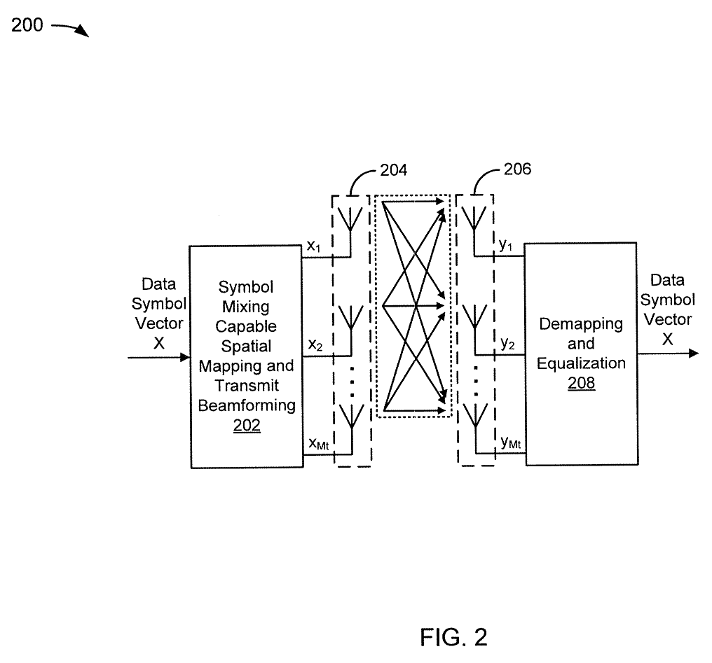

FIG. 2 depicts an example of a MIMO wireless communication system 200. The system 200 includes a mapping and transmit beamforming block 202, a transmit (Tx) antennae array 204, a receive (Rx) antennae array 206, and a demapping and equalization block 208. The MPC communication subsystem 106 (FIG. 1) can be implemented as a MIMO wireless communication system. Components of the system 100 (FIG. 1), such as the symbol mixing block 104, can be implemented as part of the system 200, but there is no actual requirement; the components of system 100 may or may not be manufactured separately, and configured for use with the system 200 later. Whether combined during manufacture or not, the MIMO wireless communication system 200 becomes a symbol-mixing-capable MIMO wireless communication system when combined with the components of FIG. 1.

In the example of FIG. 2, the spatial mapping and transmit beamforming block 202 has a vector of transmit symbols, V, as input, and a vector of transmit symbols, W, as output. The spatial mapping and transmit beamforming block 202 maps the vector of transmit symbols, W, onto the Tx antennae array 204. The antennae of the Tx antennae array 204 make up multiple parallel channels and enable the mapping of data onto Nₛ independent spatial streams with different antennae weights. The Tx antennae array 204 is depicted as a transmitting antennae array in the example of FIG. 1, but the antennae need not be dedicated to transmission, and could be used to receive as well. However, for the purpose of this example, only transmission is discussed.

The spatial mapping and transforming beamforming block 202 and the Tx antennae array 204 can be implemented on a wireless station. A station, as used in this paper, may be referred to as a device with a media access control (MAC) address and a physical layer (PHY) interface to a wireless medium that complies with the IEEE 802.11 standard. In alternative embodiments, a station may comply with a different standard than IEEE 802.11, or no standard at all, may be referred to as something other than a “station,” and may have different interfaces to a wireless or other medium. IEEE 802.11a-1999, IEEE 802.11b-1999, IEEE 802.11g-2003, IEEE 802.11-2007, and IEEE 802.11n TGn Draft 8.0 (2009) are incorporated by reference. As used in this paper, a system that is 802.11 standards-compatible or 802.11 standards-compliant complies with at least some of one or more of the incorporated documents' requirements and/or recommendations, or requirements and/or recommendations from earlier drafts of the documents.

In the example of FIG. 2, the Rx antennae array 206 receives the vector of receive symbols, Y, from the Tx antennae array 204. Typically, the channels introduce noise. So where a distinction is to be drawn between the transmit channels and the receive channels, the transmit channels can be designated Mₜ, and the receive channels can be designated Mᵣ and the vector of receive symbols, Y, includes noise. (In an OFDM system yₖ includes noise, nₖ, which is Mᵣ×1 received noise vector at tone k). The Rx antennae array 206 is depicted as receiving in the example of FIG. 2, but the antennae need not be dedicated to receiving, and could be used to transmit as well. However, for the purpose of this example, only receiving is discussed.

In the example of FIG. 2, the demapping and equalization block 208 has Y as input; and data symbol vector V and feedback as output. Conceptually, the demapping and equalization block 208 reverses the operation of the spatial mapping and transmit beamforming block 202 and the MIMO channel 210 to obtain the data symbol vector V. In a specific implementation, a demapper of the demapping and equalization block 208 demaps the signal received over each antennae on separate spatial streams and an equalizer of the demapping and equalization block 208 compensates for channel distortion and interference. Feedback can be provided to a channel estimator (see, e.g., FIG. 1, the channel estimation block 108).

Equalizers can be linear or non-linear. The most common linear equalizer is a minimum mean-square error (MMSE) equalizer, which achieves good performance with relatively low complexity. This or some other applicable convenient technology can be implemented, but the MMSE equalizer is used here as an example. It should initially be recognized that yₖC^{1/2}Hₓxₖ+nₖ=C^{1/2}H_{eff,k}Xₖ=nₖ, where C is the path power gain (includes reciprocal of path loss & shadowing power gain) and H_{eff,k} is effective Mᵣ×Nₛ channel. Average SNR across signal bandwidth per receive antenna: SNR=C*Mₜ*P/(N*N₀). SINR for tone k and stream I using an MMSE equalizer: SINR_{k,l}^{MMSE}={[(I+H*_{eff,k}H_{eff,k}C/N₀)−1]_{l,l}}⁻¹−1, k=0, . . . , N−1, I=1, . . . , Nₛ.

Referring once again to the example of FIG. 1, the channel estimation block 108 has feedback as input from the MPC communication subsystem 106 and channel estimation parameters as output. The channel estimation block 108 determines channel characteristics from the feedback, and provides the channel estimation parameters to the one-size-fits-all modulation and coding block 102, the symbol mixing block 104, the symbol unmixing block 108, and the demodulation and decoding block 110. The channel estimation block may or may not also receive input from other components of the system 100, such as the one-size-fits-all modulation and coding block 102, but such input is optional depending upon the implementation and/or configuration. Channel estimation can be accomplished using an applicable convenient technique.

In the example of FIG. 1, the symbol unmixing block 110 has data symbol vector V as input and data symbol vector X as output. Conceptually, the symbol unmixing block 110 reverses the operation of the symbol mixing block 104.

In the example of FIG. 1, the one-size-fits-all channel deallocation block 112 has the data symbol vector X as input and data bits as output. Conceptually, the one-size-fits-all channel deallocation block 112 reverses the operation of the one-size-fits-all channel allocation block 102. In operation, the data symbol vector X is passed through a demodulator and decoder to recover the data bits initially provided from the application to the one-size-fits-all channel allocation block 102.

In an embodiment, the system 100 can operate with or without symbol mixing depending upon implementation, configuration, and/or environmental variables. When operating without symbol mixing, applicable known or convenient spatial mapping and transmit beamforming techniques can be implemented. Some examples of transmit beamforming techniques without symbol mixing include SVD; per-antenna, per-tone SVD scaling; and per-antenna, SVD scaling across all tones. These techniques are generally associated with different per tone signal to interference-plus-noise ratio (SINR).

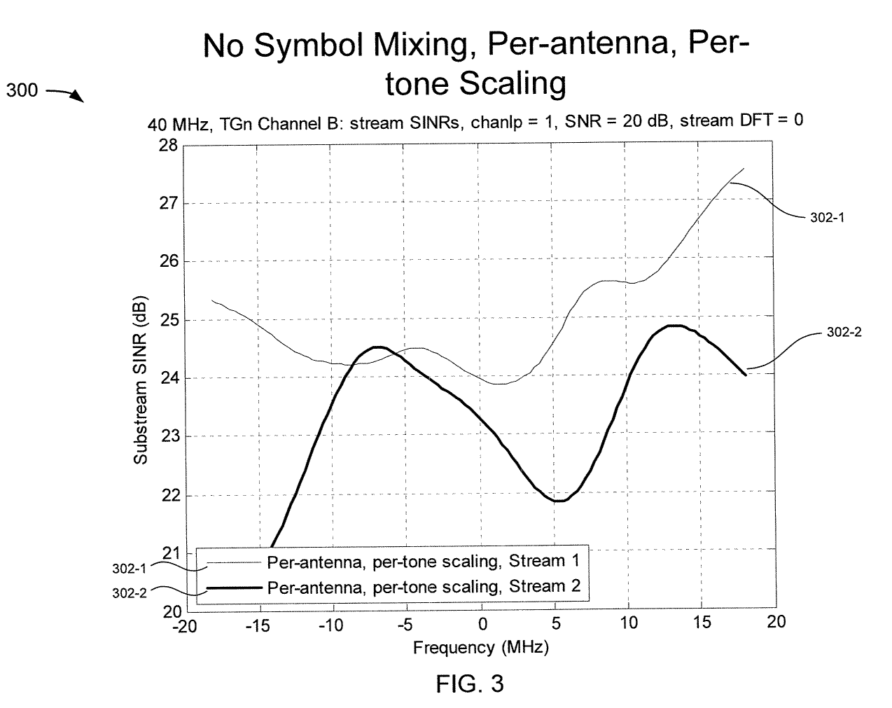

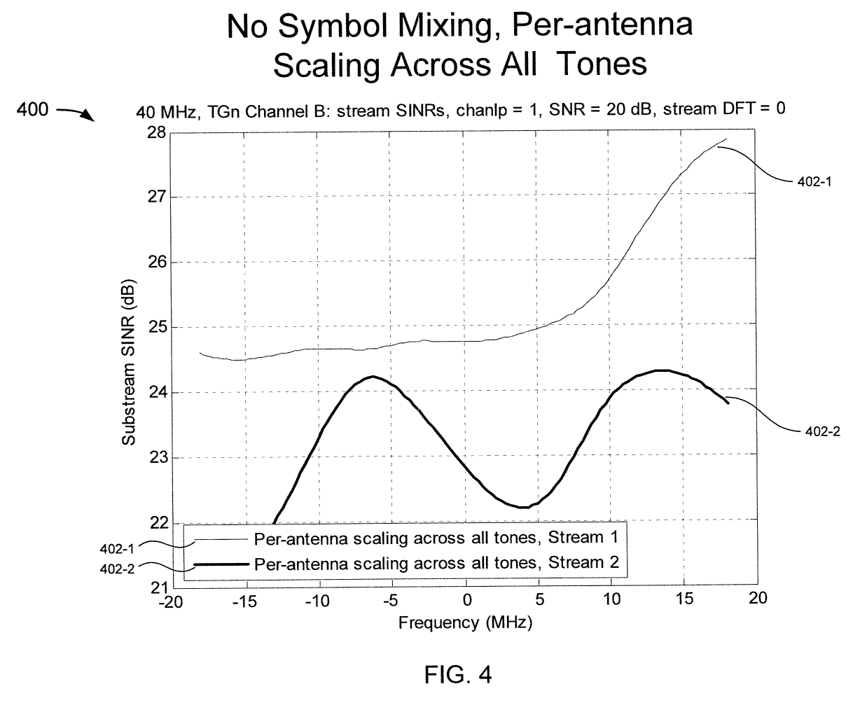

FIGS. 3 and 4 depict illustrative examples of SINR across frequencies in an OFDM system for spatial streams not using symbol mixing. As a first example, consider transmit beamforming without symbol mixing: per-antenna, per-tone SVD scaling. FIG. 3 depicts a 4×4 SINR example of two spatial streams 302-1, 302-2 (collectively, spatial streams 302) using per-antenna, per-tone SVD scaling. As is shown in FIG. 3, the spatial streams 302 have different SINRs that vary across frequency. Although in the example of FIG. 3, the MIMO is a 4×4 configuration, in various embodiments, 2×2, 2×4, 6×6, 4×8, 8×8, or some other MIMO configuration can be used.

As a second example, consider transmit beamforming without symbol mixing: per-antenna, SVD scaling across all tones. FIG. 4 depicts a 4×4 SINR example of two spatial streams 402-1, 402-2 (collectively, the spatial streams 402) using per-antenna, SVD scaling across all tones. As is shown in FIG. 4, the spatial streams 402 have different SINRs that vary across frequency.

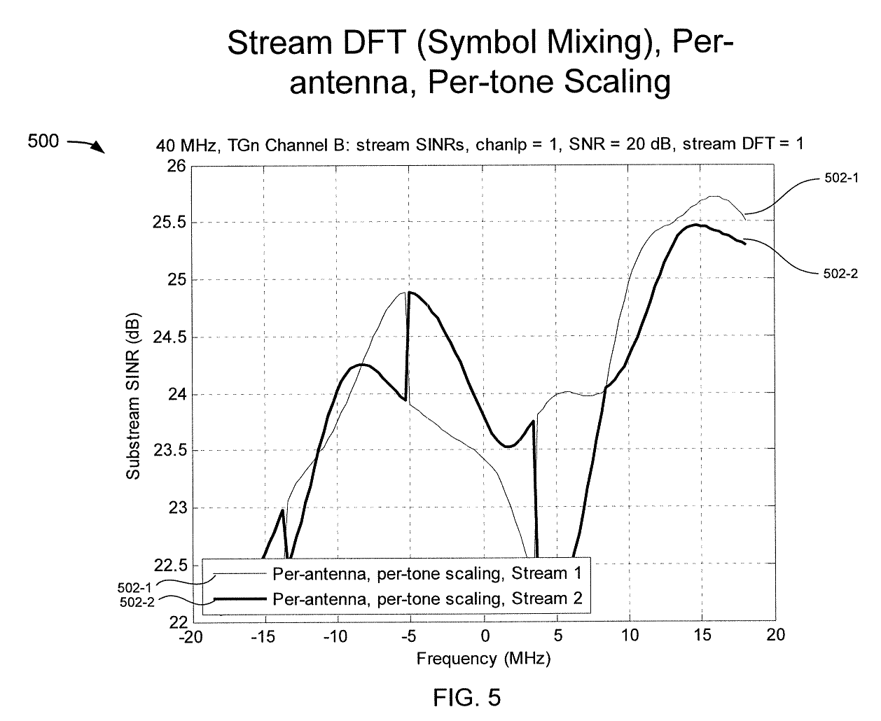

FIGS. 5-7 depict illustrative examples of SINR across frequencies for spatial streams using symbol mixing. As a third and fourth example, consider symbol mixing in per-antenna SCD scaling schemes. In this example, antennae multiplication is used to send linear combinations of modulated, coded symbols over different spatial streams.

As the third example, use per-antenna, per-tone scaling with stream DFT. FIG. 5 depicts a 4×4 SINR example of two spatial streams 502-1, 502-2 (collectively, the spatial streams 502) using per-antenna, per-tone scaling with symbol mixing. As shown in FIG. 5, the spatial streams 502 tend toward SINR equalization for each stream. This may provide improved PER, throughput, and range relative to a similar scheme without symbol mixing. (See, e.g., FIG. 3 for a comparison without symbol mixing.)

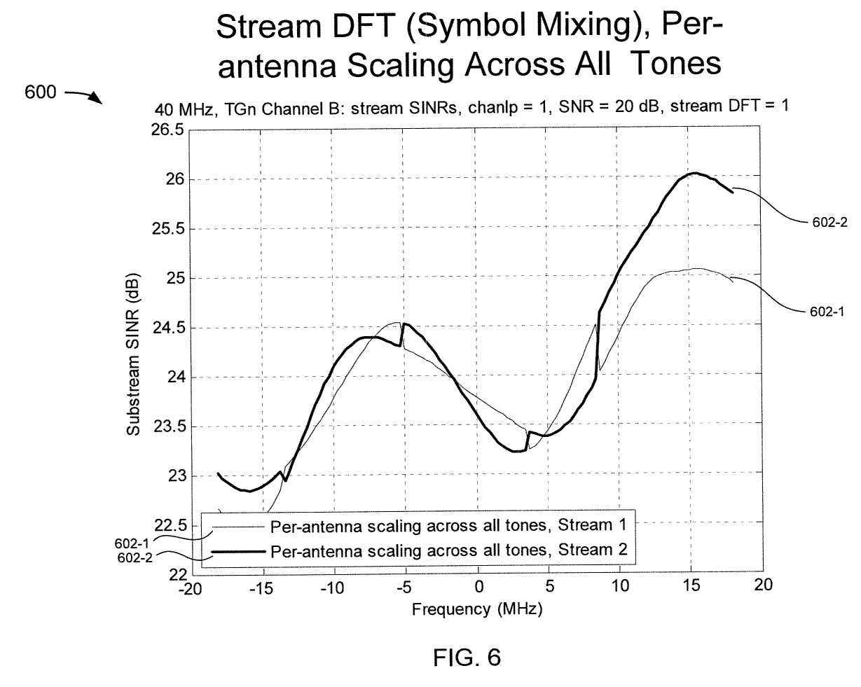

As the fourth example, use per-antenna scaling across all tones with stream DFT. FIG. 6 depicts a 4×4 SINR example of two spatial streams 602-1, 602-2 (collectively, the spatial streams 602) using per-antenna scaling across all tones with symbol mixing. As shown in FIG. 6, the spatial streams 602 tend toward SINR equalization for each stream. This may provide improved PER, throughput, and range relative to a similar scheme without symbol mixing. (See, e.g., FIG. 4 for a comparison without symbol mixing.)

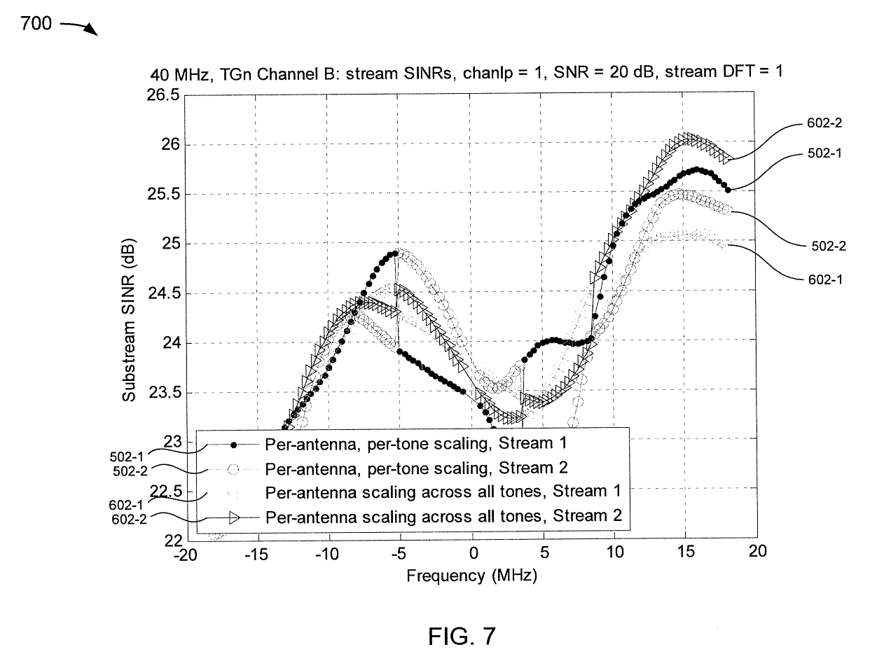

FIG. 7 depicts a 4×4 SINR symbol mixing example combining the spatial streams 502 and the spatial streams 602. FIG. 7 is intended to show how, with symbol mixing, spatial streams tend toward SINR equalization for each stream.

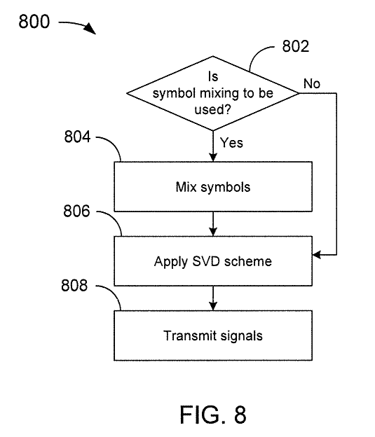

FIG. 8 depicts a flowchart 800 of an example of a method for alternately operating a wireless station with and without the use of symbol mixing. For example, symbol mixing might be used when all spatial streams are desired to have the same performance, whereas symbol mixing might not be used when it is desired for some spatial streams to have better performance, e.g. because they are higher priority. This method and other methods are depicted as serially arranged modules. However, modules of the methods may be reordered, or arranged for parallel execution as appropriate. In the example of FIG. 8, the flowchart 800 starts at decision point 802 with determining whether symbol mixing is to be used. If it is determined that symbol mixing is to be used (802-Y), then the flowchart 800 continues to module 804 with mixing symbols, and then continues to module 806. If, on the other hand, it is determined that symbol mixing is not to be used (802-N), then the flowchart 800 skips the module 804 and continues to module 806. In the module 806, an SVD scheme is applied and the flowchart 800 continues to the module 808 with transmitting signals. Using this technique, it is possible to introduce a system that is capable of symbol mixing, but is not required to always use symbol mixing.

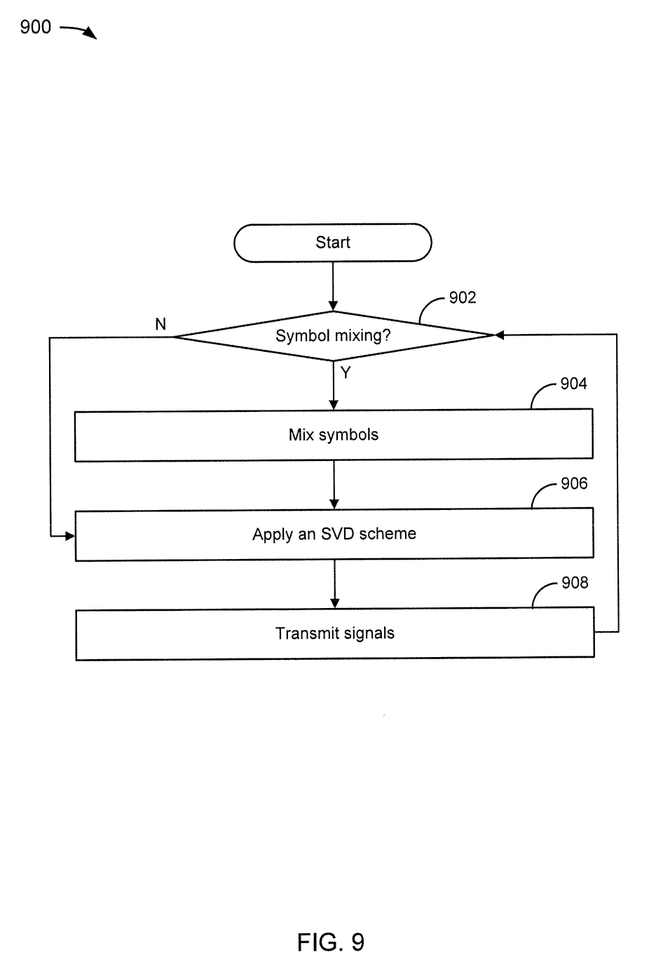

FIG. 9 depicts a flowchart 900 of an example of a method for symbol mixing. This method and other methods are depicted as serially arranged modules. However, modules of the methods may be reordered, or arranged for parallel execution as appropriate.

In the example of FIG. 9, the flowchart 900 starts at module 902 with transforming data bits from an application into a data symbol vector for multiple parallel channels. In this example, the data symbol vector can be represented as X=[x₁, . . . , x_{Ns}], for dimension Nₛ.

In the example of FIG. 9, the flowchart 900 continues to module 904 with mixing the data symbol vector into a vector of transmit symbols in accordance with estimated channel parameters and/or bit priorities. The mixed vector of transmit symbols can be represented as V=[v₁, . . . v_{N}] where each element of V is a linear combination of [x₁, . . . , x_{Ns}]. Estimated channel parameters can, for example, be determined from feedback from the receiver side of the channel. Bit priorities are associated with the data bits received from the application.

In the example of FIG. 9, the flowchart 900 continues to module 906 with transmitting the mixed vector of transmit symbols on multiple MPC communication subsystem channels. The MPC communication subsystem can include wireless MIMO, OFDM, multiple physical cables, or some other communication subsystem with spatial or frequency channels, or a combination thereof.

In the example of FIG. 9, the flowchart 900 continues to module 908 with receiving a vector of receive symbols from the MPC communication subsystem. The vector of receive symbols is the transmit symbols combined with noise introduced on the channels.

In the example of FIG. 9, the flowchart 900 continues to module 910 with removing noise from the vector of receive symbols to derive the transmitted symbols.

In the example of FIG. 9, the flowchart 900 continues to module 912 with unmixing the transmitted symbols to obtain the pre-mixed data symbol vector.

In the example of FIG. 9, the flowchart 900 continues to module 914 with deriving data bits from the data symbol vector.

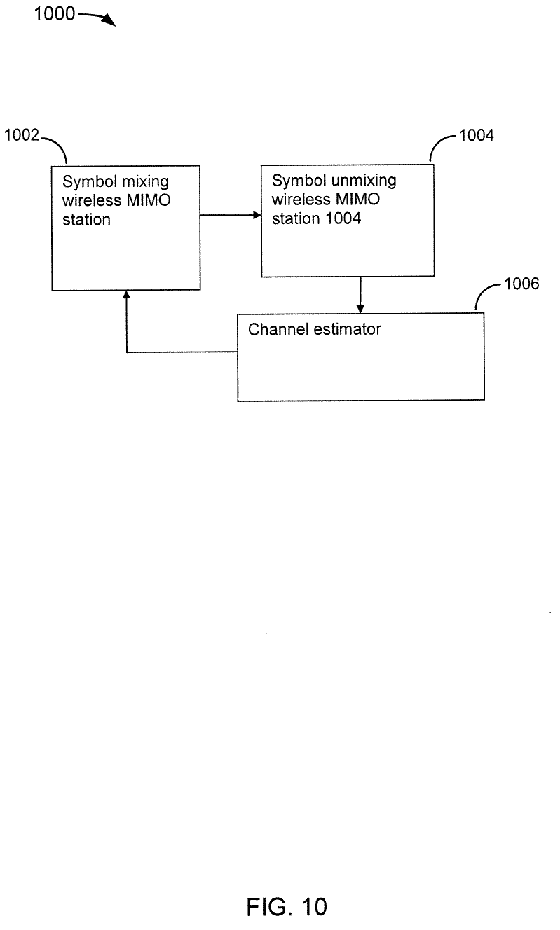

FIG. 10 depicts an example of a system 1000 that includes wireless MIMO stations. The system 1000 includes a symbol mixing wireless MIMO station 1002, a symbol unmixing wireless MIMO station 1004, and a channel estimator 1006. In the example of FIG. 10, in operation, the symbol mixing wireless MIMO station 1002 transmits a vector of mixed symbols to the symbol unmixing wireless MIMO station 1004. The symbol unmixing wireless MIMO station 1004 provides feedback to the channel estimator 1006, which is provided to the symbol mixing wireless MIMO station 1002. With the feedback, the symbol mixing wireless MIMO station can take into account channel characteristics when mixing a next set of symbols.

With reference to FIG. 1, the symbol mixing wireless MIMO station 1002 of FIG. 10 can include the components 102, 104 and the symbol unmixing wireless MIMO station 1004 of FIG. 10 can include the components 110, 112. With reference to FIG. 2, the symbol mixing wireless MIMO station 1002 of FIG. 10 can include the components 202, 204, 206 and the symbol unmixing wireless MIMO station 1004 of FIG. 10 can include the components 208, 210, 212.

Systems described herein may be implemented on any of many possible hardware, firmware, and software systems. Algorithms described herein are implemented in hardware, firmware, and/or software that is implemented in hardware. The specific implementation is not critical to an understanding of the techniques described herein and the claimed subject matter.

As used in this paper, an engine includes a dedicated or shared processor and, hardware, firmware, or software modules that are executed by the processor. Depending upon implementation-specific or other considerations, an engine can be centralized or its functionality distributed. An engine can include special purpose hardware, firmware, or software embodied in a computer-readable medium for execution by the processor. As used in this paper, the term “computer-readable storage medium” is intended to include only physical media, such as memory. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

As used in this paper, the term “embodiment” means an embodiment that serves to illustrate by way of example but not necessarily by limitation.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

1. A system comprising:
a one-size-fits-all channel allocation engine;
a symbol mixing engine;
wherein, in operation,
the one-size-fits-all modulation and coding engine has data bits as input from an application and transforms the data bits into a data symbol vector X;
the symbol mixing engine has the data symbol vector X as input and transforms the data symbol vector X in accordance with bit priorities associated with the data bits into a transmit data symbol vector V for output to a multiple parallel channel (MPC) communication subsystem.

2. The system of claim 1, wherein the one-size-fits-all channel allocation engine includes a modulation and coding engine.

3. The system of claim 1, wherein the symbol mixing engine includes a bit prioritization engine that determines the bit priorities.

4. The system of claim 1, further comprising:
the MPC communication subsystem, wherein the MPC communication subsystem includes a multiple input multiple output (MIMO) wireless communication system.

5. The system of claim 1, further comprising:
the MPC communication subsystem, wherein the MPC communication subsystem includes an orthogonal frequency division multiplexing (OFDM) system.

6. The system of claim 1, further comprising:
the MPC communication subsystem, wherein the MPC communication subsystem includes a parallel cable system.

7. The system of claim 1, further comprising:
a channel estimation engine coupled to the MPC communication system, wherein, in operation, the channel estimation engine provides estimated channel parameters to the symbol mixing engine, and wherein the symbol mixing engine maps in accordance with channel estimation parameters.

8. The system of claim 1, further comprising:
a channel estimation engine coupled to the MPC communication system, wherein, in operation, the channel estimation engine provides estimated channel parameters to the one-size-fits-all channel allocation engine, and wherein the one-size-fits-all channel allocation engine maps in accordance with channel estimation parameters.

9. The system of claim 1, further comprising: a symbol unmixing engine coupled to the symbol mixing engine, wherein, in operation, the symbol unmixing engine reverses the operation of the symbol mixing engine.

10. The system of claim 1, further comprising: a one-size-fits-all channel deallocation engine coupled to the one-size-fits-all channel allocation engine, wherein, in operation, the one-size-fits-all channel deallocation engine reverses the operation of the one-size-fits-all channel allocation engine.

11. The system of claim 1, wherein the symbol mixing engine can be deactivated with respect to symbol mixing.

12. A system comprising:
a modulation and coding engine;
a symbol mixing engine coupled to the modulation and coding engine;
a spatial mapping and transmit beamforming engine coupled to the spatial mapping and transmit beamforming engine;
an antennae array coupled to the symbol mixing engine;
a channel estimation engine coupled to the symbol mixing engine;
wherein, in operation,
the modulation and coding engine transforms data bits from an application into a data symbol vector X;
the symbol mixing engine transforms the data symbol vector X into a vector of transmit symbols V in accordance with estimated channel parameters associated with the MIMO wireless channel, where each element of V is a function of a subset of elements of X;
the spatial mapping and transmit beamforming engine maps the vector of transmit symbols V onto the antennae array for transmission over a multiple input multiple output (MIMO) wireless channel;
the channel estimation engine provides the estimated channel parameters to the symbol mixing engine.

13. The system of claim 12, wherein the modulation and coding engine, the symbol mixing engine, the spatial mapping and transmit beamforming engine, and the antennae array are implemented in a wireless station.

14. The system of claim 12, wherein the antennae array includes a transmit (Tx) antennae array that, further comprising:
a receive (Rx) antennae array coupled to the Tx antennae array;
a spatial demapping and equalization engine coupled to the Rx antennae array;
a symbol unmixing engine coupled to the Rx array;
a demodulation and decoding engine coupled to the symbol demixing engine;
wherein, in operation, the Rx antennae array receives a vector of transmit symbols Y;
the spatial demapping and equalization engine removes noise introduced at least in part by the MIMO wireless channel and reverses the operation of the spatial mapping and transmit beamforming engine to derive the vector of transmit symbols V from the vector of transmit symbols Y;
the symbol demixing engine reverses the operation of the symbol mixing engine to derive the vector of transmit symbols X from the vector of transmit symbols V;
the demodulation and decoding engine reverses the operation of the modulation and coding engine to derive the data bits from the data symbol vector X.

15. The system of claim 14, wherein the spatial demapping and equalization engine provides feedback associated with the MIMO wireless channel to the channel estimator.

16. The system of claim 14, wherein the Rx antennae array, the spatial demapping and equalization engine, the symbol unmixing engine, and the demodulation and decoding engine are implemented in a wireless station.

17. The system of claim 12, further comprising a bit prioritization engine coupled to the symbol mixing engine, wherein, in operation, the bit prioritization engine provides the symbol mixing engine data sufficient to transform the data symbol vector X in accordance with a data bit prioritization scheme.

18. A method comprising:
transforming data bits from an application into a data symbol vector;
mixing symbols of the data symbol vector into a transmit data symbol vector for output to a multiple parallel channel (MPC) communication subsystem in accordance with bit priorities associated with the data bits and estimated channel parameters associated with channels of the MPC communication subsystem;
transmitting the transmit data symbol vector onto the MPC communication subsystem.

19. The method of claim 17, wherein the data bits are first data bits, further comprising:
transforming second data bits from an application into an unmixed transmit data symbol vector;
transmitting the unmixed transmit data symbol vector onto the MPC communication subsystem.

20. The method of claim 17, further comprising:
at a receiver, removing noise introduced at least in part by channels of the MPC communication subsystem;
unmixing symbols of the data symbol vector;
deriving the data bits from the symbols.
